(19) United States
(12) Patent Application Publication
(10) Pub. No.: US 2026/0191233 A1
(43) Pub. Date: Jul. 9, 2026

(54) LIQUID BEVERAGE COMPOSITION CONTAINING WHEY PROTEIN AND PREPARATION METHOD THEREFOR

(71) Applicant: DAESANG WELLIFE CORPORATION, Seoul (KR)

(72) Inventors: Gyu Whan LEE, Seoul (KR); Jun Hee LEE, Seoul (KR); Sung Pyo LEE, Seoul (KR); Jae Seok CHO, Seoul (KR)

(21) Appl. No.: 18/994,926

(22) PCT Filed: Jul. 5, 2023
(86) PCT No.: PCT/KR2023/009471

§ 371 Date: Jan. 15, 2025

(30) Foreign Application Priority Data
Jul. 15, 2022 (KR) 10-2022-0087658

(51) Int. Cl. A23L 2/38; A23B 2/40; A23C 21/08; A23L 29/10; A23L 29/238; A23L 29/256; A23L 29/262

(52) U.S. Cl. CPC A23L 2/38; A23B 2/40; A23C 21/08; A23L 29/10; A23L 29/238; A23L 29/256; A23L 29/262

(57) ABSTRACT

The present invention relates to a protein liquid beverage composition containing protein, particularly whey protein, and a preparation method therefor, and allows liquefaction by increasing the emulsion stability of a product through an appropriate preparation process. This ensures high-quality protein supplementation and thus may not only prevent sarcopenia but may also improve nutritional status, and help improve quality of life.

### TECHNICAL FIELD

The present invention relates to a beverage composition and a preparation method therefor, and specifically to a liquid protein beverage composition containing whey protein and a method for preparing the same.

### BACKGROUND ART

Whey refers to a liquid remaining after harvesting curds formed during the preparation of cheese from milk. If this whey is not properly processed, it may result in loss of food resources and environmental and economic burden. Furthermore, the consumption of cheese is increasing along with the current wellness trend, in addition, there is an active movement to prepare farm-style cheese. As cheese preparation increases, whey may act as a major pollutant, however, it can also be used as a variety of materials in the food industry.

In fact, whey proteins offer a wide range of functionality, including solubility, viscosity, water retention, foaming, emulsification and gel formation. Due to these characteristics, whey protein has the advantage of being widely developed as a functional material for use in a wide range of foods.

However, although the whey protein is a high-quality protein compared to other protein sources, it has a difficulty in securing heat stability and is sensitive to pH, thus, hardly liquefied. Therefore, whey protein powder is usually used for manufacturing beverages using the whey protein, thereby making it difficult to apply to liquid beverages.

### PRIOR ART DOCUMENT

### Patent Document

(Patent Document 1) Korean Patent Laid-Open Publication No. 10-2014-0022514
(Patent Document 2) Korean Patent Registration Publication No. 10-2133770

### SUMMARY OF INVENTION

### Problems to be Solved by Invention

In order to solve the above problems, it is an object of the present invention to provide a method for preparing a high-quality protein beverage containing whey protein, which has excellent emulsion stability and capability of being liquefied, as well as a liquid beverage composition containing whey protein prepared by the preparation method mentioned above.

### Means for Solving Problems

In order to achieve the above object, the present invention provides a method for preparing a liquid beverage containing whey protein, comprising the following steps:
(a) dissolving a raw material in purified water;
(b) first homogenizing a product that has passed through step (a);
(c) cooling the product homogenized in step (b);
(d) sterilizing the product cooled in step (c); and
(e) second homogenizing the product sterilized in step (d).

Step (a) is a step of dissolving the raw material required for a liquid beverage containing protein in purified water, and preferably dissolving the raw material at 50 to 70° C., but it is not limited thereto. If the temperature is less than the above temperature range, it may cause a problem in the protein hydration process. On the other hand, if the temperature exceeds the above temperature range, precipitant may occur in the final product due to protein denaturation.

The raw material includes protein, and the protein is preferably whey protein, but it is not limited thereto. In one embodiment of the present invention, the whey protein may be 100% whey protein concentrate, but it is not limited thereto.

The whey protein may be included in an amount of 0.1 to 30 parts by weight (‘wt. parts’), and more preferably 1 to 25 wt. parts, based on a total protein beverage composition, but it is not limited thereto. If the amount thereof is less than the above range, it may cause a problem with high-quality protein intake. Further, if the amount thereof exceeds the above range, a sense of difference may be felt due to a dull mouthfeel.

The raw material supplied other than the whey protein may include stabilizers and vitamins, and further include fat, carbohydrates, etc. for balanced supply of nutrients.

The stabilizer may include any one or more selected from gums, emulsifiers, crystalline cellulose, and carrageenan.

The gums may include any one or more selected from gum arabic, xanthan gum, guar gum and gellan gum, etc., but they are not limited thereto.

The emulsifiers may include any one or more selected from sorbitan fatty acid ester, glycerin fatty acid ester and soybean lecithin, etc., but they are not limited thereto.

The gums may be included in an amount of 0.01 to 0.5 wt. parts, and preferably 0.01 to 0.1 wt. parts, based on the total protein beverage composition. If the amount thereof deviates from the above range, there is a risk that a degree of precipitation may increase or the emulsion stability may be reduced.

The emulsifier may be included in an amount of 0.1 to 5 wt. parts, and preferably 0.1 to 1 wt. part, based on the total protein beverage composition. If the amount thereof deviates from the above range, there is a risk that the degree of precipitation may increase or the emulsion stability may be reduced.

The crystalline cellulose may be included in an amount of 0.1 to 5 wt. parts, and preferably 0.1 to 1 wt. part, based on the total protein beverage composition. If the amount thereof deviates from the above range, there is a risk that the degree of precipitation may increase or the emulsion stability may be reduced.

The carrageenan may be included in an amount of 0.01 to 1 wt. part, and preferably 0.01 to 0.1 wt. parts, based on the total protein beverage composition. If the amount thereof deviates from the above range, there is a risk that the degree of precipitation may increase or the emulsion stability may be reduced.

Step (b) is a step of first homogenizing the product that has passed through step (a), and is preferably performed at a homogenizing pressure of 200 bar or more, more preferably 200 to 400 bar, and further preferably 300 to 400 bar. If the homogeneous pressure is less than 200 bar, raw materials included in the liquid phase may be precipitated or the emulsion stability may be reduced. Further, if the pressure exceeds 400 bar, preparation efficiency may be reduced.

Step (c) is a step of cooling the product homogenized in step (b), and the cooling temperature may be 20 to 40° C., and preferably 20 to 30° C. If the temperature is less than the above temperature range, there is a risk that the quality of the product may be deteriorated due to an occurrence of microorganisms. On the other hand, if the temperature exceeds the above temperature range, the amount of precipitant may increase during long-term storage, and the emulsion stability may be reduced.

Step (d) is a step of sterilizing the product cooled in step (c), and the sterilization temperature may be 140° C. or higher, preferably 140 to 150° C., and more preferably 145 to 150° C. If the temperature is less than the above temperature range, microorganisms may be generated thus to cause a deterioration in the quality of the product. Further, if the temperature exceeds the above temperature range, the degree of precipitation of the raw material may increase, and the emulsion stability may be reduced.

The sterilization time is not limited, but in one embodiment of the present invention, sterilization may be performed for 1 to 10 seconds.

Furthermore, the sterilization step is preferably performed by a direct steam injection (DSI) process, but it is not limited thereto. The DSI process is a direct steam injection method, which transfers heat faster than the indirect steam injection method used in the existing beverage preparation process, thereby enabling sterilization in a short period of time. Further, there is no heat loss rate as steam is directly injected into the product to heat it, such that sterilization may be performed at the exact temperature. In addition, in the case of whey protein, which has poor heat stability, minimizing the exposure time to high temperature may have excellent effects on the emulsion stability and precipitation of the product, and has the advantage of preserving the flavor and nutrition of the product well.

Step (e) is a step of second homogenizing the product sterilized in step (d), and may be homogenized at a homogenization pressure of less than 200 bar, and preferably 50 to 100 bar. If the second homogenization step is not performed or homogenization is performed outside the above homogenization pressure, the precipitation degree and the emulsion stability of the raw materials in the liquid phase may be reduced.

Further, the present invention may provide a liquid beverage composition containing protein.

The liquid beverage composition according to the present invention may contain protein. The protein is preferably whey protein, but it is not limited thereto, and in one embodiment of the present invention, the whey protein may be 100% whey protein concentrate, but it is not limited thereto.

The whey protein may be included in an amount of 0.1 to 30 wt. parts, and more preferably 1 to 25 wt. parts, based on the total protein beverage composition, but it is not limited thereto. If the amount thereof is less than the above range, there may be a problem with quality protein intake or unbalanced product design. Further, if the amount thereof exceeds the above range, there may be a problem with protein hydration. In addition, in one embodiment of the present invention, the whey protein may be 100% whey protein concentrate, but it is not limited thereto.

The raw material supplied other than the whey protein may include stabilizers and vitamins, and may additionally further include fat, carbohydrates, etc. for balanced supply of nutrients.

The stabilizer includes any one or more selected from gums, emulsifiers, crystalline cellulose, and carrageenan.

The gums may include any one or more selected from gum arabic, xanthan gum, guar gum and gellan gum, etc., but they are not limited thereto.

The emulsifiers may include any one or more selected from sorbitan fatty acid ester, glycerin fatty acid ester and soybean lecithin, etc., but they are not limited thereto.

The gums may be included in an amount of 0.01 to 0.5 wt. parts, and preferably 0.01 to 0.1 wt. parts, based on the total protein beverage composition. If the amount thereof deviates from the above range, there is a risk that the degree of precipitation may increase or the emulsion stability may be reduced.

The emulsifier may be included in an amount of 0.1 to 5 wt. parts, and preferably 0.1 to 1 wt. part, based on the total protein beverage composition. If the amount thereof deviates from the above range, there is a risk that the degree of precipitation may increase or the emulsion stability may be reduced.

The crystalline cellulose may be included in an amount of 0.1 to 5 wt. parts, and preferably 0.1 to 1 wt. part, based on the total protein beverage composition. If the amount thereof deviates from the above range, there is a risk that the degree of precipitation may increase or the emulsion stability may be reduced.

The carrageenan may be included in an amount of 0.01 to 1 wt. part, and preferably 0.01 to 0.1 wt. parts, based on the total protein beverage composition. If the amount thereof deviates from the above range, there is a risk that the degree of precipitation may increase or the emulsion stability may be reduced.

In addition, the present invention may provide a stabilizer composition for preparing protein beverages.

The stabilizer composition for preparing protein beverages is the same as the stabilizer in the present invention.

The protein liquid beverage composition or protein liquid beverage prepared according to the present invention not only has high emulsion stability of the product, but also endow high-quality protein supplementation to prevent sarcopenia, improve nutritional status, and may help improve quality of life.

### Advantageous Effects

The present invention provides a protein liquid beverage composition containing protein, particularly whey protein, with improved emulsion stability, and a method for preparing the same. The protein liquid beverage according to the present invention may prevent sarcopenia by ensuring high-quality protein supplementation. Further, it may help improve nutritional status and quality of life.

### BRIEF DESCRIPTION OF DRAWINGS

FIG. 1 shows the preparation process of a liquid beverage composition according to the present invention.

FIG. 2 is a schematic diagram of Turbiscan for evaluating emulsion stability.

FIGS. 3A and 3B show the results of emulsion stability less than 200 bar and the emulsion stability between 300 and 400 bar in Experimental Example 1, respectively.

FIGS. 4A and 4B show the emulsion stability results in Experimental Example 3 when the sterilization temperature was 145 to 150° C. and above 150° C., respectively.

FIGS. 5A and 5B show the emulsion stability results in Experimental Example 3 when the second homogeneous pressure was less than 100 bar and more than 300 bar, respectively.

FIG. 6 shows the results of Examples 1 and 2 in Experimental Example 5.

FIGS. 7A and 7B show the precipitation result and the emulsion stability result of Example 3 in Experimental Example 5.

FIGS. 8A and 8B show the precipitation result and the emulsion stability result of Example 4 in Experimental Example 5.

FIGS. 9A and 9B show the precipitation results and the emulsion stability result of Example 5 in Experimental Example 5.

FIGS. 10A and 10B show the precipitation result and the emulsion stability result of Example 6 in Experimental Example 5.

FIGS. 11A and 11B show the precipitation result and the emulsion stability result of Example 7 in Experimental Example 5.

FIGS. 12A and 12B show the precipitation result and the emulsion stability result of Example 8 in Experimental Example 5.

FIGS. 13A and 13B show the precipitation result and the emulsion stability result of Example 9 in Experimental Example 5.

FIGS. 14A and 14B show the result of the heat preservation test of Example 8 in Experimental Example 6.

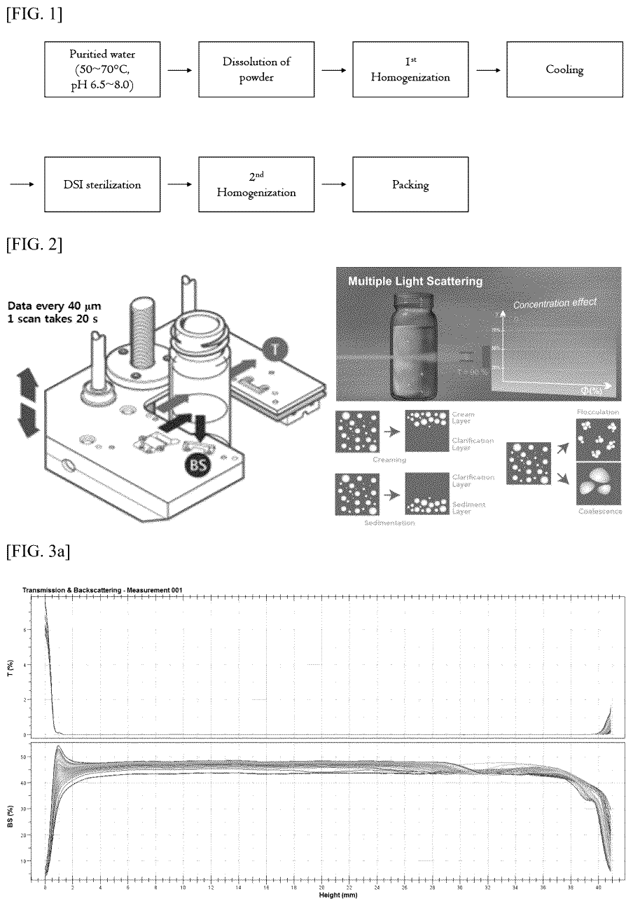

### MODE FOR CARRYING OUT INVENTION

Hereinafter, the present invention will be described in detail through examples and experimental examples.

However, the following examples and experimental examples only illustrate the present invention, and the content of the present invention is not limited to the following examples and experimental examples.

### <Examples 1 to 9> Preparation of Protein Liquid Beverage Composition According to the Present Invention

Whey proteins and raw materials were dissolved in purified water at 50 to 70° C., first homogenization was performed at 300 to 400 bar homogenization pressure, and then cooled at 20 to 30° C. The cooled product was sterilized at 140 to 150° C., followed by a second homogenization step at a homogenizing pressure of 50 to 100 bar thus to prepare a final product.

Among the raw materials used in this case, the stabilizer was prepared according to the mixing ratio listed in Table 1 below. The weight of each component in Table 1 refers to parts by weight (wt. parts) based on the entire composition, and the process at each stage was selected based on the results of the following experimental examples.

TABLE 1

| | | | Crystalline | |
|---|---|---|---|---|
| | Gums | Emulsifier | cellulose | Carageenan |
| Example | 0.01 to 0.1 wt. | — | 0.1 to 0.5 | — |
| 1 | part of gum | | wt. part | |
| | arabic, | | | |
| | 0.01 to 0.05 wt. | | | |
| | part of xanthan | | | |
| | gum | | | |
| Example | 0.01 to 0.1 wt. | 0.5 to 1 wt. | — | — |
| 2 | part of gum | part of soybean | | |
| | arabic, | lecithin | | |
| | 0.01 to 0.05 wt. | | | |
| | part of xanthan | | | |
| | gum | | | |
| Example | 0.01 to 0.05 wt. | — | — | 0.03 to 0.05 |
| 3 | part of gellan | | | wt. parts |
| | gum | | | |
| Example | — | — | 0.1 to 0.5 | 0.03 to 0.05 |
| 4 | | | wt. part | wt. parts |
| Example | 0.01 to 0.05 wt. | | 0.1 to 0.5 | 0.03 to 0.05 |
| 5 | part of gellan | | wt. part | wt. parts |
| | gum | | | |
| Example | — | 0.1 to 0.5 wt. | 0.1 to 0.5 | 0.03 to 0.05 |
| 6 | | part of sorbitan | wt. part | wt. parts |
| | | acid ester | | |
| Example | 0.01 to 0.05 wt. | 0.1 to 0.5 wt. | — | 0.03 to 0.05 |
| 7 | part of gellan | part of sorbitan | | wt. parts |
| | gum | fatty acid ester | | |
| Example | 0.01 to 0.05 wt. | 0.1 to 0.5 wt. | 0.1 to 0.5 | 0.03 to 0.05 |
| 8 | part of gellan | part of sorbitan | wt. part | wt. parts |
| | gum | acid ester | | |
| Example | 0.01 to 0.05 wt. | 0.1 to 0.5 wt. | 0.1 to 0.5 | 0.03 to 0.05 |
| 9 | part of gellan | part of sorbitan | wt. part | wt. parts |
| | gum | acid ester | | |

### <Method of Confirming Emulsion Stability in Experimental Examples>

There are two ways to confirm emulsion stability: measuring an emulsion stability index of nano/microemulsion using the Turbiscan; and direct confirmation using a measuring cylinder and measuring the amount of precipitant. Among these, Turbiscan is an optical analyzer suitable for analyzing physical and physicochemical properties of actual solutions using the intensity of light transmission and back-scattered light generated from a light source. The operating principle of this analysis equipment is that a light source generates light at an interval of 40 μm in a 70 mm-height glass cylindrical vial containing a sample, and a change in the intensity of transmitted or scattered light may be collected thus to observe the state of the sample and a change in the size of particles in the sample over time (see FIG. 2).

In the following experimental example, the prepared product was preserved and injected into a cylindrical vial to reach a size of about 50 mm, the vial was mounted on a Turbiscan, followed by measuring the intensities of transmitted light and scattered light at 55° C. with 0, 1, 2, 12 and 24 hours interval for 5 days using a near-infrared light source (λ=880 nm). Afterwards, in order to evaluate the stability index (SSI) of the suspension based on the intensity of transmitted light, the intensity of transmitted light measured using the Turbiscan was calculated through the following equation.

A0 is a sum of the intensities of transmitted light measured at an interval of 40 μm in an initially 50 mm sample, while At is a sum of the transmitted light intensities measured at an interval of 40 μm in a 50 mm sample after t time. When a change in the stability of the sample occurs, the intensity of transmitted light is decreased due to an increase in the size, agglomeration or precipitation, etc. of the particles. Through this, the dispersion stability of the product over time may be determined.

### <Experimental Example 1> Evaluation of Precipitation Degree and Emulsion Stability According to Homogeneous Pressure in the First Homogenization Step

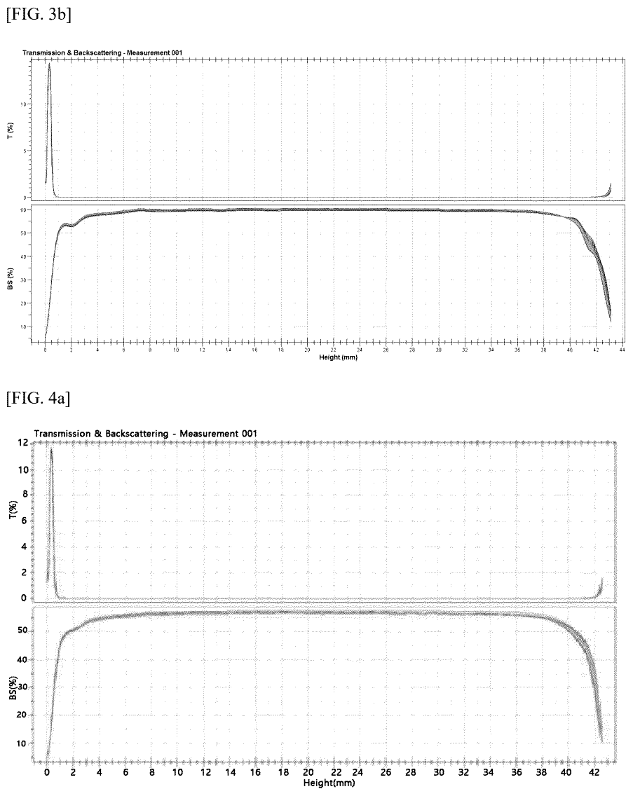

In the preparation process of Example 1, changes in precipitation degree and the emulsion stability were evaluated when preparing a liquid beverage by varying the homogenization pressure in the first homogenization step. Results thereof are shown in Table 2 and FIGS. 3A and 3B. In Table 2, the results are indicated as O for excellent, A for average, and X for poor.

As a result of the experiment, when confirmed visually, a lot of precipitant was formed due to large particles in the case of pressures less than 200 bar, and an unstable profile was confirmed in an emulsion stability test using the Turbiscan. In the case of 200 to 300 bar, satisfactory data was confirmed in the emulsion stability results, but some precipitant was found. When setting a homogeneous pressure exceeding 300 bar, a stable degree of emulsification and precipitation could be confirmed. However, in the case of exceeding 400 bar, considering the possibility of overloading the machine, it was determined that a final homogenizing pressure of 300 to 400 bar is preferable.

TABLE 2

| | Less than | 200 to | 300 to | More than |
|---|---|---|---|---|
| | 200 bar | 300 bar | 400 bar | 400 bar |
| Results of precipitation | X | Δ | ◯ | ◯ |
| degree and the emulsion | | | | |
| stability | | | | |

### <Experimental Example 2> Evaluation of Product Stability According to Cooling Temperature

According to the results of Experimental Example 1, the first homogenization pressure was set to 300 to 400 bar, and the cooling temperature was varied to evaluate whether the degree of emulsification and precipitant formation of the product varied depending on the cooling temperature in the cooling step after the first homogenization step, thus assessing the product completeness. Results thereof are shown in Table 3, and in Table 3, the results are indicated as O for excellent, Δ for average, and X for poor.

As a result of the experiment, when the sterilization process was performed directly without cooling, the product was exposed to high temperatures for a long period of time, thus confirming unstable emulsification and a large amount of precipitant in the final product. At 30 to 40° C., the amount of precipitant was increased in the long term and the emulsion stability showed to be unstable. Further, when cooled less than 20° C., it actually affected the sterilization process and the problem of microorganisms was highlighted. Ultimately, it was confirmed that cooling to 20 to 30° C. had an excellent effect on the overall product quality.

TABLE 3

| | Less than | 20 to | 30 to | Not |
|---|---|---|---|---|
| | 20° C. | 30° C. | 40° C. | cooling |
| Results of precipitation | Δ | ◯ | Δ | X |
| degree and the emulsion stability | | | | |

### <Experimental Example 3> Evaluation of Effect of Sterilization Temperature

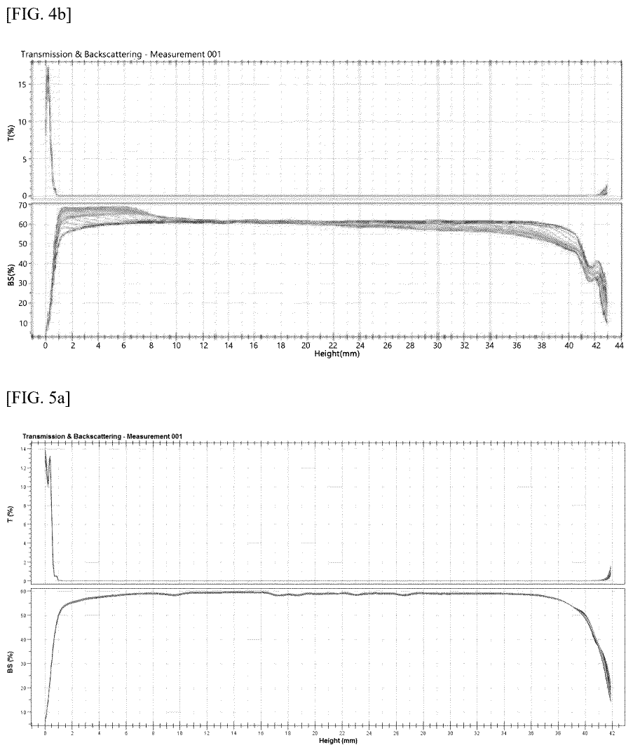

According to the results of Experimental Example 2, the cooling temperature was set to 20 to 30° C., and the emulsion stability and microorganism formation were evaluated to assess the effect of sterilization temperature on the subsequent sterilization step. Considering the characteristics of whey protein ingredients that are unstable at high temperature and the possibility of protein denaturation, the sterilization time was set to 4 seconds, and the microbial specifications were tested based on the general bacterial count according to the Food Code (n=5, c=1, m=100, M=1,000). Results thereof are shown in Tables 4 and 5 and FIGS. 4A and 4B. In Tables 4 and 5, the results are indicated as O for excellent, Δ for average, and X for poor.

As a result of the evaluation, under the sterilization temperature exceeding 150° C., denaturation of protein due to high temperature was confirmed, resulting in large particles and a large amount of precipitant. In the case of microorganism testing, microorganisms of the standard value or more were found at less than 140° C., and results meeting the standard were confirmed for temperatures between 14° and 145° C. However, the above conditions were determined to be unsuitable for safety of the product within the expiration period. Consequently, as a result of confirming the emulsion stability and microbial results, it was determined that conditions of 145 to 150° C. were preferable.

TABLE 4

| | Less than | 140 to | 145 to | More than |
|---|---|---|---|---|
| | 140° C. | 145° C. | 150° C. | 150° C. |
| Result of precipitation | ◯ | ◯ | ◯ | X |
| degree and the emulsion | | | | |
| stability | | | | |

TABLE 5

| | Less than | 140 to | 145 to | More than |
|---|---|---|---|---|
| | 140° C. | 145° C. | 150° C. | 150° C. |
| Generation of | X | Δ | ◯ | ◯ |
| microorganisms | | | | |

### <Experimental Example 4> Evaluation of Emulsion Stability According to Second Homogenization Conditions

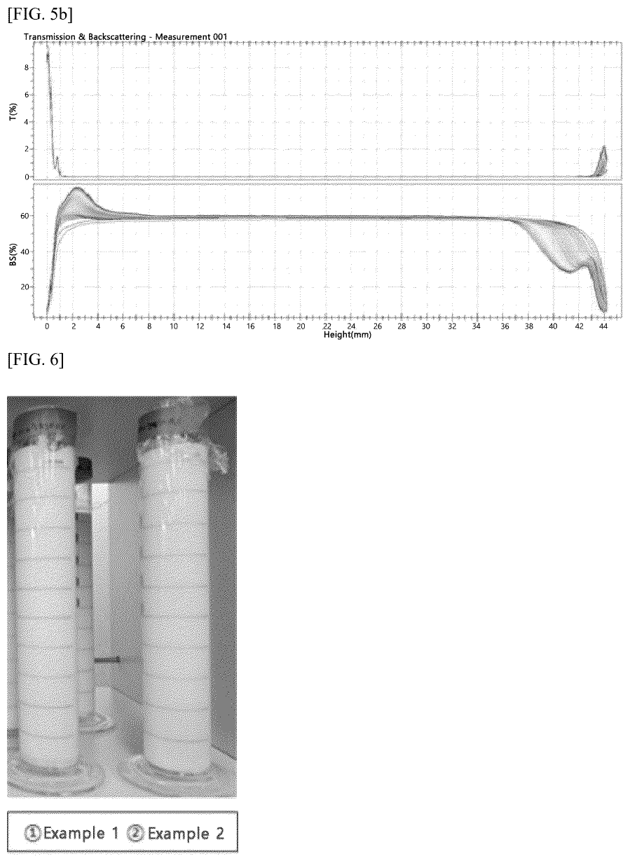

According to the results of Experimental Example 3, the sterilization temperature was set to 145 to 150° C. and, in order to assess the effect on emulsion stability according to the homogenization pressure, the precipitation and emulsification results were measured 2 weeks after the second homogenization. In this experiment, second homogenization was performed. Results thereof are shown in Table 6 and FIGS. 5A and 5B. In Table 6, the results are indicated as O for excellent, Δ for average, and X for poor.

As a result of the evaluation, when second homogenization was not performed, particles and a large amount of precipitant could be confirmed visually. Second homogenization under 100 bar showed good effects on precipitation and the emulsion stability. The product homogenized at 100 to 200 bar showed similar results to the emulsion stability of the product homogenized at less than 100 bar, but a slight precipitation of about 2 to 3 mm was confirmed. Unlike the first homogenization, as the second homogenization pressure increased, the amount of precipitant increased, and the emulsion stability was also confirmed to be poor.

TABLE 6

| | Not | Less than | 100 to | 200 to | More than |
|---|---|---|---|---|---|
| | implement | 100 bar | 200 bar | 300 bar | 300 bar |
| Result of | X | ◯ | Δ | X | X |
| precipitation | | | | | |
| degree and the | | | | | |
| emulsion stability | | | | | |

### <Experimental Example 5> Evaluation of Emulsion Stability According to Mixing Ratio of Stabilizer

By combining the results of Experimental Examples 1 to 4, a protein liquid beverage was prepared and monitored for about 2 months. As a result, it showed slight precipitant and unstable emulsion stability. In order to prevent precipitation and improve emulsion stability within the expiration period, Examples 1 to 9 were used to assess whether emulsion stability was increased according to the combination of stabilizers.

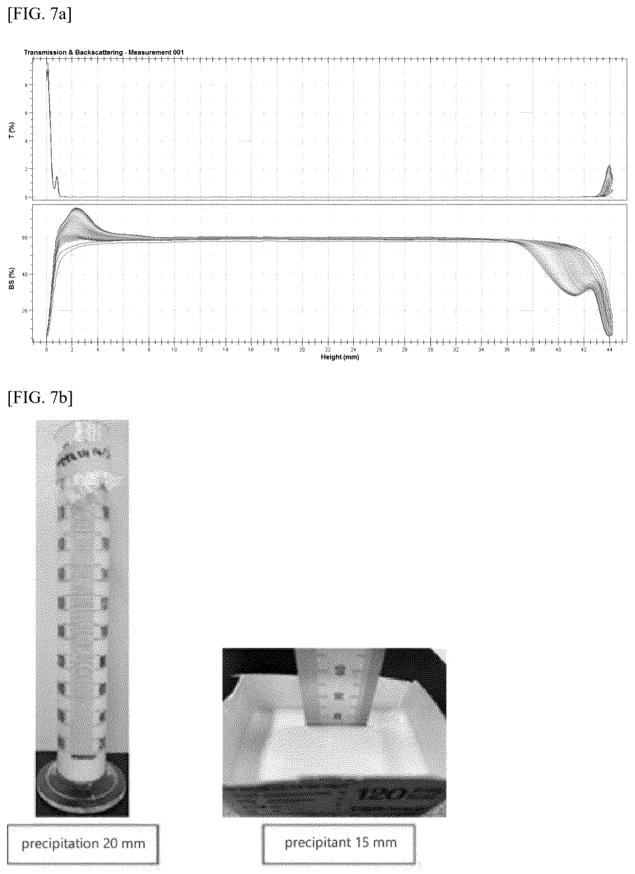

As a result of the evaluation, in Example 1, when gum arabic, xanthan gum and crystalline cellulose were used, the amount of highly viscous precipitant was relatively reduced, but the particles were coarse and the product hardened over time. In Example 2, when gum arabic, xanthan gum and soybean lecithin were used, high viscosity precipitants could not be observed, but it was confirmed that separation of the fat layer occurred (FIG. 6).

In Example 3, when gellan gum and carrageenan were used, it was confirmed that the emulsion stability is unstable by observing the separation of upper and lower profiles, and a large amount of highly viscous precipitant was confirmed (FIGS. 7A and 7B).

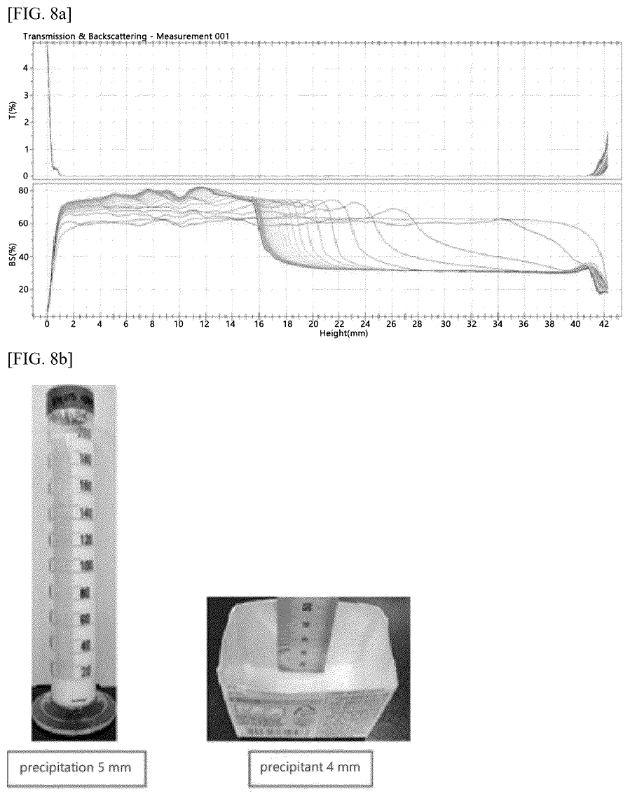

In Example 4, when crystalline cellulose and carrageenan were used, the absolute amount of precipitant was reduced, but the overall unstable emulsion stability was confirmed through the profile (FIGS. 8A and 8B).

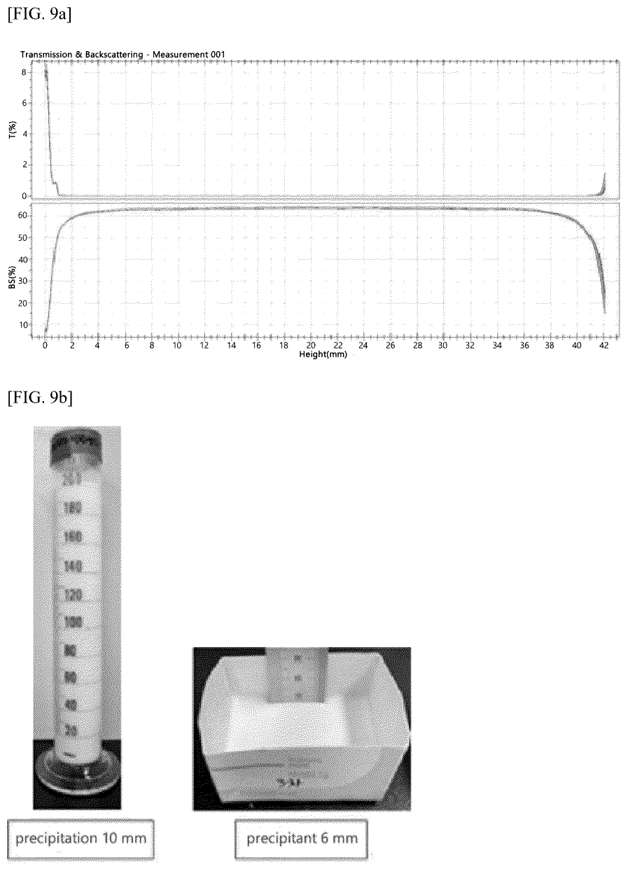

In Example 5, it could be seen that, when gellan gum was added to the stabilizer composition of the previous examples, the profile to confirm emulsion stability was very good. However, in the aspect of long-term period, highly viscous precipitant was confirmed at the bottom of the product (FIGS. 9A and 9B).

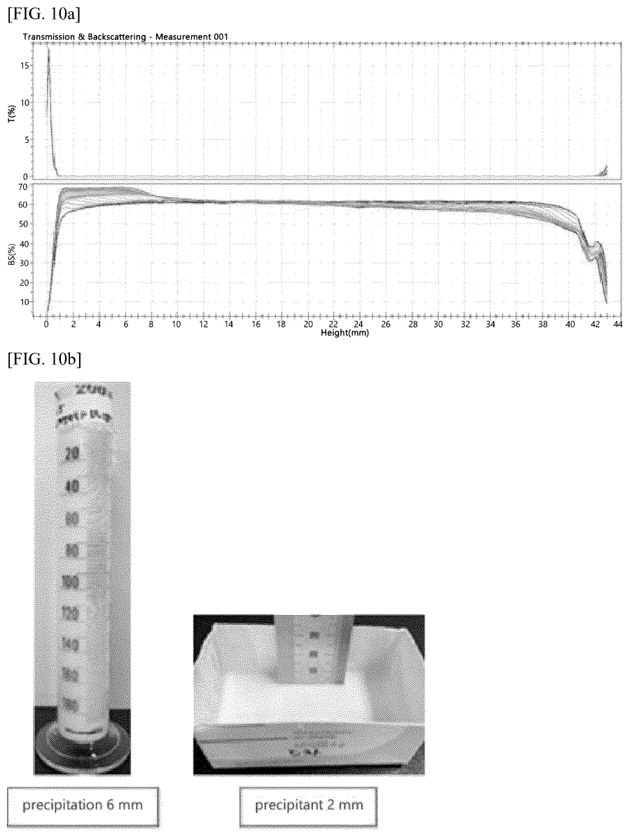

In Example 6, when crystalline cellulose, carrageenan and sorbitan fatty acid ester were used, the overall amount of precipitant was improved, but since the profiles did not completely overlap in the emulsion stability section, precipitant is expected to continue to form within the expiration period of the product (FIGS. 10A and 10B).

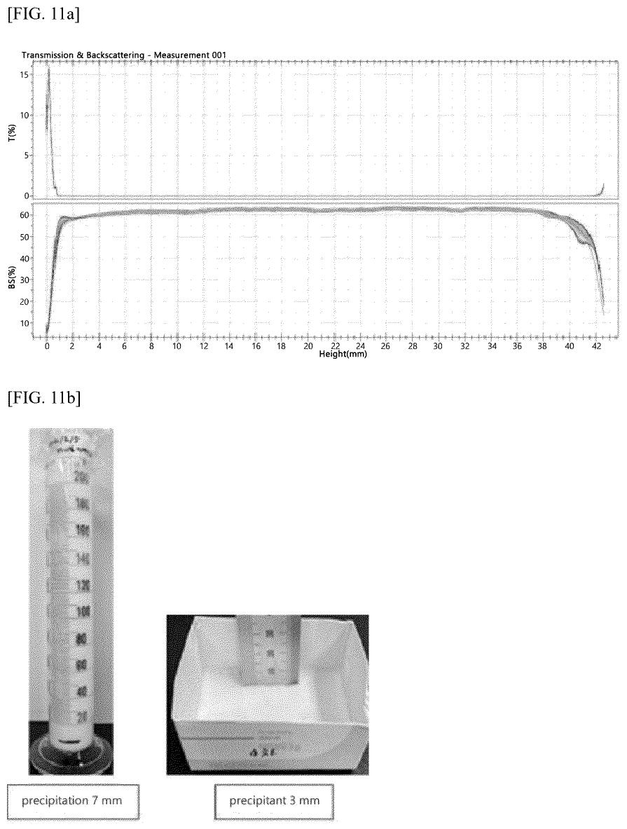

In Example 7, when gellan gum, carrageenan and sorbitan fatty acid ester were used instead of the crystalline cellulose, the absolute amount of precipitant was significantly reduced compared to the stabilizer composition No. 1, but the amount of precipitant was found to be slightly increased compared to composition No. 4 (FIGS. 11A and 11B).

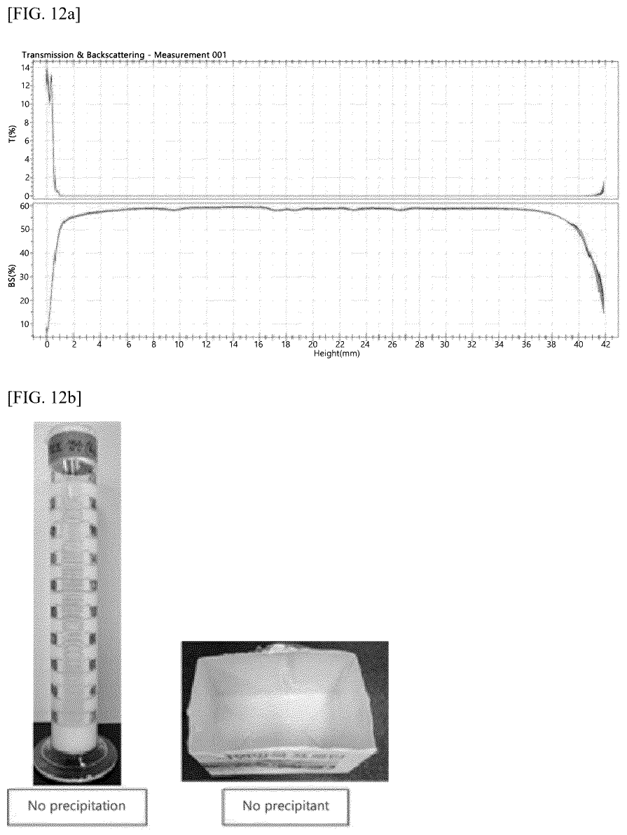

In Example 8, the emulsion stability was confirmed to be stable in the overall profile, and it was confirmed to have excellent emulsion stability, as can be seen in the state of the precipitant at the bottom of the measuring cylinder and the product (FIGS. 12A and 12B).

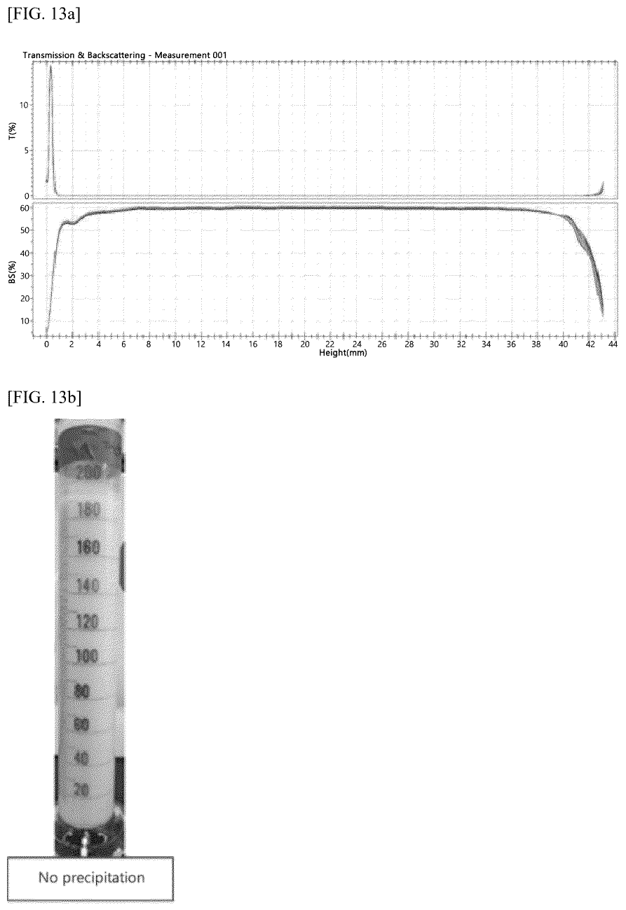

In Example 9, the emulsion stability results when changed to glycerin fatty acid ester showed almost the same shape as sorbitol fatty acid ester, but the effect as an antifoaming agent during the preparation process was low, and difficulties were experienced during the preparation process, such that it was determined to be unsuitable (FIGS. 13A and 13B).

### <Experimental Example 6> Evaluation of Emulsion Stability Through Heating Preservation Test

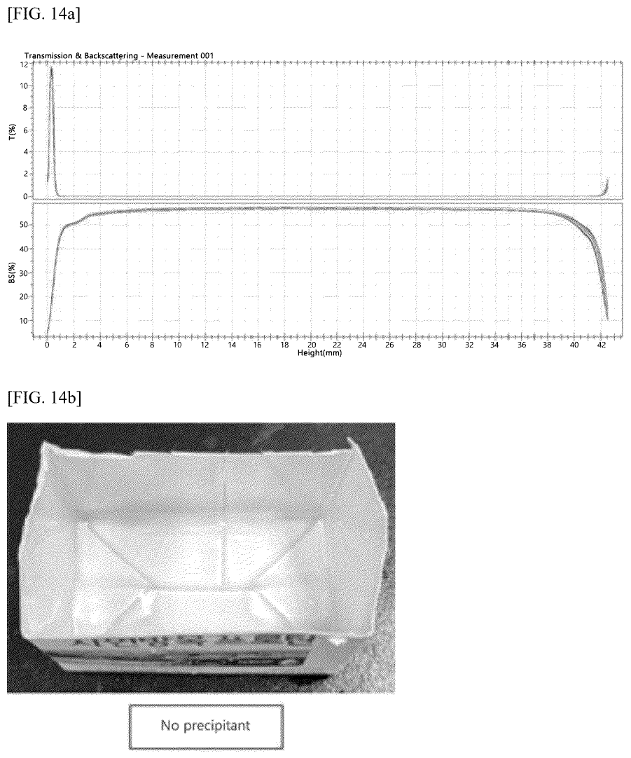

A heating preservation test was conducted using Example 8, which had the best emulsion stability in Experimental Example 5. In the heat preservation test, a protein liquid beverage was prepared using Example 8, and the physicochemical properties and the emulsion stability were evaluated after a 2-month heat storage test (55° C.). The experimental results are shown in FIGS. 14A and 14B.

As a result of the evaluation, quality stability within the distribution period may be predicted through a heat preservation test in a harsh environment of high temperature. In general, when exposed to high temperatures for a long period of time, protein denaturation or separation occurs, emulsion stability decreases, and a large amount of precipitant is generated. However, in the case of products made with the technology according to the present invention, it was able to confirm an evenly similar profile, which may be interpreted as excellent emulsion stability. Further, since there was no precipitant, it is possible to prepare a protein beverage composition using whey protein through the preparation process described above and the use of appropriate stabilizers.

1. A method for preparing a liquid beverage containing whey protein, comprising the following steps:
(a) dissolving whey protein and raw materials in purified water;
(b) first homogenizing a product that has passed through step (a);
(c) cooling the product homogenized in step (b);
(d) sterilizing the product cooled in step (c); and
(e) second homogenizing the product sterilized in step (d).

2. The method for preparing a liquid beverage containing whey protein according to claim 1, wherein the dissolution temperature in step (a) is 50 to 70° C.

3. The method for preparing a liquid beverage containing whey protein according to claim 1, wherein the whey protein in step (a) is included in an amount of 1 to 25 parts by weight (‘wt. parts’) based on a total protein beverage composition.

4. The method for preparing a liquid beverage containing whey protein according to claim 1, wherein the whey protein in step (a) is whey protein concentrate.

5. The method for preparing a liquid beverage containing whey protein according to claim 1, wherein the raw materials in step (a) include a stabilizer, and
wherein the stabilizer includes any one or more selected from gums, emulsifiers, crystalline cellulose, and carrageenan.

6. The method for preparing a liquid beverage containing whey protein according to claim 5, wherein the gum includes any one or more selected from gum arabic, xanthan gum, guar gum and gellan gum, which is included in amount of 0.01 to 0.1 wt. parts, based on the total protein beverage composition.

7. The method for preparing a liquid beverage containing whey protein according to claim 5, wherein the emulsifier includes any one or more selected from sorbitan fatty acid ester, glycerin fatty acid ester and soybean lecithin, which is included in an amount of 0.1 to 1 wt. part, based on the total protein beverage composition.

8. The method for preparing a liquid beverage containing whey protein according to claim 5, wherein the crystalline cellulose is included in an amount of 0.1 to 1 wt. part, based on the total protein beverage composition.

9. The method for preparing a liquid beverage containing whey protein according to claim 5, wherein the carrageenan is included in an amount of 0.01 to 0.1 wt. parts, based on the total protein beverage composition.

10. The method for preparing a liquid beverage containing whey protein according to claim 1, wherein the first homogenization in step (b) is performed at a homogenization pressure of 200 to 400 bar.

11. The method for preparing a liquid beverage containing whey protein according to claim 1, wherein the cooling in step (c) is performed at 20 to 30° C.

12. The method for preparing a liquid beverage containing whey protein according to claim 1, wherein the sterilization in step (d) is performed at 140 to 150° C.

13. The method for preparing a liquid beverage containing whey protein according to claim 1, wherein the second homogenization in step (e) is performed at a homogenization pressure of 50 to 100 bar.
